(19) United States
(12) Patent Application Publication
(10) Pub. No.: US 2004/0116541 A1
(43) Pub. Date: Jun. 17, 2004

(54) Method for preparing a monodispersed double emulsion

(76) Inventors: Fernando Leal Calderon, Impasse Jamin (FR); Jerome Michel Jacques Bibette, Boulan-Bordeaux (FR)

Correspondence Address: YOUNG & THOMPSON, 745 SOUTH 23RD STREET 2ND FLOOR, ARLINGTON, VA, 22202

(21) Appl. No.: 10/275,322

(22) PCT Filed: May 9, 2001
(86) PCT No.: PCT/FR01/01397

(30) Foreign Application Priority Data
May 9, 2000 (FR) 00/05880

(51) Int. Cl. B01F 3/08

(52) U.S. Cl. 516/54

(57) ABSTRACT

A method for preparing a monodispersed double water/oil/water emulsion, comprises: a) subjecting a polydispered oil-in-water emulsion Ei comprising 55 to 99 wt. % of an aqueous phase, to a controlled shearing to obtain the corresponding monodispersed invert emulsion; b) adding to the emulsion, without phase inversion, the necessary amount of diluting oil phase so that the aqueous phase of the resulting emulsion represents at least 50 wt. % of the emulsion total weight; and c) introducing the resulting emulsion into a high pressure homogenizer, together with a continuous aqueous phase, the respective amounts of the emulsion and the continuous aqueous phase being such that the resulting double emulsion comprises up to 50 wt. % of invert emulsion droplets relative to the emulsion total weight, the continuous aqueous phase comprising a hydrophilic surfactant concentration not more that 0.02 times the critical micellar concentration.

The invention relates to a method for preparing monodisperse double emulsions, of water-in-oil-in-water type, by employing a high pressure homogenizer.

The advantage of double emulsions is widely recognized in fields as varied as those of pharmaceuticals, cosmetics, crop protection, foodstuffs and/or coatings of paint type.

Double emulsions of water-in-oil-in-water type make possible in particular the encapsulation of various active substances in the aqueous internal phase. This is because, under highly specific conditions, it is possible to bring about release of the encapsulated active substances while controlling their kinetics of release.

In the art, monodisperse double emulsions are a particular target because of their homogeneity: they make possible in particular a uniform and controllable release of the active materials.

Various methods for preparing monodisperse emulsions are known: a first method is that disclosed in EP 442 831 and EP 517 987. This method involves the fractionation of a polydisperse starting primary emulsion by successive creamings. It is lengthy and tiresome and not easily applicable to the industrial scale. A second method is disclosed in FR 97/00690. It consists in subjecting a viscoelastic starting primary emulsion to controlled shearing so that the same maximum shearing is applied to the entire emulsion. This method has various advantages and makes possible in particular control of the size of the droplets of the monodisperse emulsion obtained.

When either of these methods is applied to a double emulsion, it is essential not to destroy the double emulsion, for example by causing the droplets forming the emulsion to coalesce or by bringing about premature, escape of the active principle.

Under these conditions, it is understood that the development of a method for preparing a monodisperse double emulsion of water-in-oil-in-water type which does not consist simply in applying either of the methods of the prior art to the corresponding polydisperse double emulsion is most desirable.

The invention is targeted at solving this problem by providing a novel method for preparing a monodisperse double emulsion by use of a high pressure homogenizer.

In the context of the present description the double emulsion of water-in-oil-in-water type is composed of droplets (or globules) of a monodisperse inverse emulsion dispersed in an aqueous continuous phase (or aqueous external phase), the inverse emulsion being itself composed of droplets of an aqueous internal phase dispersed in an oily phase.

According to the invention, the term “monodisperse” characterizes emulsions for which the particle size distribution of the droplets of disperse phase is very narrow.

The distribution is considered to be very narrow when the polydispersity is less than or equal to 30% and preferably of the order of 5 to 25%, for example between 10 and 20%.

In the context of the invention, the polydispersity is defined as the ratio of the standard deviation of the curve representing the variation in the volume occupied by the dispersed material as a function of the diameter of the droplets to the mean diameter of the droplets.

The term “inverse emulsion” is understood to denote generally the dispersion of an aqueous phase in an oily phase.

The expression “direct emulsion” denotes, for its part, the dispersion of an oily phase in an aqueous phase.

Thus, the expression “monodisperse inverse emulsion” denotes an emulsion of water-in-oil type composed of droplets of an aqueous phase dispersed in an oily phase, for which emulsion the particle size distribution of the droplets of aqueous phase is very narrow (polydispersity less than 30%).

The method of the invention results in a monodisperse double emulsion, that is to say a double emulsion in which the particle size distribution of the globules is also very narrow (polydispersity less than 30%).

More specifically, the invention relates to a method for preparing a monodisperse double emulsion of water-in-oil-in-water type comprising the stages consisting in:

a) subjecting a polydisperse emulsion Ei of water-in-oil type, comprising from 50 to 99% by weight of an aqueous phase, to controlled shearing so that the same maximum shearing is applied to the entire emulsion, so as to obtain the corresponding monodisperse inverse emulsion;

b) adding (to said emulsion, without phase inversion, the necessary amount of a diluting oily phase, so that the aqueous phase of the resulting emulsion represents less than 50% by weight of the total weight of the emulsion; and

c) introducing the resulting emulsion into a high pressure homogenizer, together with an aqueous continuous phase, the respective amounts of said emulsion and of said aqueous continuous phase being such that the resulting monodisperse double emulsion comprises up to 50% by weight of droplets of inverse emulsion (or globules) with respect to the total weight of the emulsion, said aqueous continuous phase comprising a concentration of hydrophilic surfactant of less than or equal to 0.02 times the critical micelle concentration.

This method results in a monodisperse double emulsion composed of globules of an oil-in-water emulsion dispersed in an aqueous external phase, the globules representing at most 50% of the total weight of the double emulsion. In the double emulsion obtained, the globules are composed of droplets of an aqueous phase dispersed in an oily phase, the total aqueous phase present in the globules representing at most 50% of the total weight of all the globules.

The method of the invention is carried out starting from a polydisperse inverse emulsion Ei prepared conventionally according to any one of the known methodes of the state of the art.

The starting emulsion Ei comprises from 50 to 99% by weight of an aqueous phase, better still from 70 to 95%, for example from 80 to 90%, by weight, with respect to the total weight of the emulsion Ei.

The oily phase is immiscible with water. It comprises one or more different oils, the nature of which is not critical per se.

The term “oil” is understood to mean, according to the invention, any liquid substance, hydrophobic or not very soluble in water, capable of being emulsified in an aqueous medium in the presence or absence of one or more appropriate surfactants.

Such a hydrophobic and insoluble substance can, by an example, be an organic polymer, such as a polyorgano-siloxane, a mineral oil, such as hexadecane, a vegetable oil, such as soybean or groundnut oil, or liquid crystals (lyotropic or thermotropic).

Preferably, the oily phase comprises an aliphatic, cyclic and/or aromatic C₈-C₃₀ hydrocarbon. By way of example, the oily phase comprises dodecane.

The emulsion Ei comprises a lipophilic surfactant exhibiting a lipophilic/hydrophilic ratio (HLB value) of less than 10.

The term HLB (Hydrophlic-Lipophilic Balance) denotes the ratio of the hydrophilicity of the polar groups of the surfactant molecules to the hydrophobicity of their lipophilic part. HLB values are listed in particular in various fundamental handbooks, such as the “Handbook of Pharmaceutical Excipients”, The Pharmaceutical Press, London, 1994).

In the context of the invention, the nature of the surfactant which can be used for the stabilization of the emulsion is more particularly chosen so as to be able to ensure good stability of the emulsion.

Mention may be made, as example of appropriate surfactants, of fatty acid, preferably C₈-C₂₂ fatty acid, esters of sorbitol, such as Span 80. Another type of appropriate surfactant is polyglycerol polyricinoleate.

Span 80 is a molecular mixture derived from sorbitol, the main constituent of which is sorbitan monooleate.

Polyglycerol polyricinoleate corresponds to the formula:

R₁O—(CH₂—CH(OR₂)—CH₂O)ₙ—R₃ (II)

where

n is an integer from 2 to 12;

R₁, R₂ and R₃ each independently represent H or a radical derived from ricinoleic acid of formula (III), at least one representing this derivative:

H—[O—CH((CH₂)₅CH₃)—CH₂—CH═CH—(CH₂)₇—CO]ₘ— (III)

where

m is an integer from 2 to 10.

Preferably, n=2-10 and m=2-10; more preferably, n=2-5 and m 4-10.

Examples of commercially available polyglycerol polyricinoleate are Admul Wol 1403 (Quest), Radiamuls Poly 2253 (Fina) and Grindsted PGPR 90 (Danisco).

The polyglycerol polyricinoleates preferably used according to the invention are those by which n varies between 2 and 5 (and has a value, for example, of 3) and m varies between 5 and 10 (and has a value, for example, of 7).

When polyglycerol polyricinoleate is used as surfactant, the concentration of surfactant in the oily phase Ei varies between 60 and 99% by weight.

In some cases, the oily phase can be composed of the lipophilic surfactant alone.

In stage a), the polydisperse inverse emulsion Ei is converted to a monodisperse inverse emulsion. The technique used to do this is that disclosed in Application WO 97/38787.

It is restated below:

One means for subjecting the entire emulsion to the same maximum shearing consists in subjecting the entire emulsion to a constant shear rate.

However, the invention is not intended to be restricted to this specific embodiment.

In facts the shear rate can differ, at a given time, for two points in the emulsion.

By varying the geometry of the device used to generate the shear forces, it is possible to vary the shear rate applied to the emulsion in time and/or space.

Provided that the emulsion is flowing when subjected to shearing, each part of the emulsion can thus be subjected to a shear rate which varies over time. The shearing is said to be “controlled” when, whatever the variation over time in the shear rate, the latter passes, at a given instant which can differ from one spot to another in the emulsion, through a maximum value which is the same for every part of the emulsion.

Preferably, so as to control the shearing, the polydisperse double emulsion is introduced into an appropriate device.

Appropriate devices are disclosed in the application FR 97/00690 or in the international application WO 97/38787.

In brief, an appropriate device is a Couette cell in which shearing is constant, the Couette cell being composed of two concentric cylinders in rotation with respect to one another.

A second device is a cell composed of two parallel plates, in oscillating movement with respect to one another and between which the polydisperse inverse emulsion is forced.

Another device is a cell composed of two concentric disks in rotation with respect to one another and between which the polydisperse inverse emulsion moves.

These cells are commonly used in commercial devices, in particular rheometers which make it possible to measure the viscoelastic properties of liquids (for example: Carrimed or Rheometrics).

The maximum value of the shear rate to which the primary emulsion is subjected depends on the frequency of rotation, on the frequency of oscillation and/or on the amplitude of oscillation of the movement of the plates, cylinders and disks of the devices described above.

Generally, it has been found that a high value of the maximum shear rate results in the formation of emulsions composed of very small droplets of emulsion Ei exhibiting a very narrow particle size distribution.

In order to increase the value of the maximum shear rate, a person skilled in the art can vary several parameters, namely the frequency of rotation, the frequency of oscillation and/or the amplitude of oscillation of the movement of the plates, cylinders and disks of the devices described above, and can also vary the dimension of the respective chambers of these various devices in the direction perpendicular to the direction of the flow imposed by the movement of the surface.

It should be noted that the maximum shear rate varies linearly with the amplitude of oscillation and/or the frequency of the movement and in an inversely proportional fashion with the dimension of the chamber in a direction perpendicular to the flow.

It is preferable for the maximum shear rate to be between 1 and 1×10⁵ s⁻¹, preferably between 100 and 5 000 s⁻¹, for example between 500 and 5 000 s⁻¹.

It is important according to the invention for the flow of the starting polydisperse inverse emulsion to be homogeneous (absence of splits) during its passage through any one of the devices described above.

More specifically, when the controlled shearing is carried out by bringing said emulsion into contact with a moving solid surface, a homogeneous flow is characterized by a constant rate gradient in a direction perpendicular to the moving solid surface.

One means of controlling the flow consists in varying the dimension d of the chambers in the direction perpendicular to the direction of the flow imposed by the movement of the surface.

It should be noted that, in the case of the Couette device, this dimension d is defined by the difference (R₃−R₂), where R₂ and R₃ are respectively the radii of the internal and external cylinders of the Couette device.

In the case of the cell composed of two parallel plates in oscillating movement with respect to one another, this dimension d is defined by the distance separating the two plates in a direction which is perpendicular to them.

In the case of the cell composed of two concentric disks in rotation with respect to one another, this dimension is defined by the distance separating the two disks in the direction of the axis, of rotation of the moving disk.

Generally, a heterogeneous flow can be rendered homogeneous by reducing the size of the chamber and more particularly by reducing its dimension in the direction perpendicular to the direction of the flow.

Thus, in the case of the three devices mentioned above, the dimension d is preferably kept below 200 μm, for example between 50 and 200 μm, in particular approximately 100 μm.

On completion of stage a), an inverse emulsion with a size of the droplets of aqueous phase in dispersion of between, 0.05 μm and 50 μm, preferably between 0.1 μm and 10 μm, is generally obtained.

In stage b), the monodisperse inverse emulsion obtained in stage a) is diluted by addition of a diluting oily phase.

To do this, use may be made of an oily phase with the same composition as that constituting the emulsion Ei (which is preferred) or of an oily phase with a different composition. However, the exact nature of the diluting oily, phase is not crucial according to the invention.

Generally, the diluting oily phase is as defined above for the oily phase of the emulsion Ei.

The addition of the diluting oily phase is carried out conventionally without phase inversion. A simple method consists in adding said additive oily phase dropwise to the monodisperse inverse emulsion maintained under moderate stirring. To this end, a shearing of less than 100 s⁻¹ is generally suitable. Depending on the formulation of the inverse emulsion and in particular depending on the amount of surfactant present, it is possible to envisage other methods of addition, such as, for example, the addition all at once of the diluting oily phase to the emulsion, which is kept stirred.

After dilution, it is important for the fraction by mass of aqueous phase (ratio of the weight of the aqueous phase to the total weight of the emulsion) to be less than 0.5, preferably less than 0.35, better still less than 0.20.

According to a preferred embodiment of the invention, the viscosity of the inverse emulsion, as measured at 25°°C., is less than 0.1 Pa·s, preferably less than 0.01 Pa·s.

In stage c), the emulsion resulting from stage b), which is a monodisperse inverse emulsion, is treated in a high pressure homogenizer.

The high pressure homogenizer which can be used according to the invention is of the type commonly used for the preparation of stable emulsions from an aqueous phase and an oily phase.

Such homogenizers are in particular as described by W. Clayton in “The theory of, emulsions and their technical treatment”, 5th edition, Churchill Livingstone, London 1954; or by L. W. Phipps in “The high pressure dairy homogenizer”, The National Institute for Research in Dairying, 1985; or by H. Mulder and P. Walstra in “The milk fat globule”, Centre for Agricultural Publishing and Documentation, Wegeningen, the Netherlands, 1974; or by P. Walstra in “Formation of emulsions”, Encyclopedia of Emulsion Technology, Paul Becher, vol. 1, p. 57-127, published by Marcel Dekker, New York, 1983.

In this type of homogenizer, the liquids are forced to pass through a very narrow opening of millimetric or micrometric size at very high pressure (several hundred bar, for example 100 to 400 bar). This opening is generally placed in a valve system but it can be a slot or a simple circular orifice. The opening generally has a diameter of between 10 μm and 1 mm. On passing through this narrow opening, the emulsion is subjected to a violent acceleration and a sudden fall in pressure (the pressure downstream of the opening is in the order of 1 bar). The cavitation or shear forces and the turbulence which results therefrom provide the emulsification.

According to the invention, the inverse emulsion obtained on conclusion of stage b) and an aqueous phase, known as an aqueous continuous phase, are forced into the homogenization valve or into the orifice. Said aqueous continuous phase will constitute the aqueous external phase of the double emulsion exiting from the high pressure homogenizer. It should be understood that the aqueous continuous phase is an aqueous solution.

An example of an appropriate homogenizer is a homogenizer of Gaulin type, such as the model sold by LabPlant Limited. This model preferably does not require premixing of the phases. The inverse emulsion obtained on conclusion of stage b) and the, aqueous phase are present initially in two separate cylindrical tanks surmounted by two pistons situated downstream of a homogenization chamber. By pushing on the pistons, a press forces the two liquids to simultaneously enter the homogenization chamber before making them pass through the circular outlet orifice.

In this specific type of homogenizer, the advantageous operating conditions are:

a rate of injection of the aqueous phase and of the monodisperse inverse emulsion varying between 100 and 500 m/s, better still between 150 and 350 m/s;

a pressure in the chamber in which the inverse emulsion and the aqueous continuous phase are brought into contact of between 100 and 400 bar (from 0.1×10⁸ Pa to 0.4×10⁸ Pa);

a circular outlet orifice of the homogenization chamber of 0.1 to 1 mm.

It is the relative cross section of the cylindrical tanks positioned upstream of the homogenization chamber which determines the fraction of globules in the final double emulsion.

At the outlet of the high pressure homogenizer, a monodisperse double emulsion of water-in-oil-in-water type is recovered.

This emulsion is characterized by:

the fact that the globules (or droplets of monodisperse inverse emulsion), represent at most 50% of the total weight of the emulsion;

the total aqueous phase present in the globules represents at most 50% of the total weight of all the globules.

The aqueous continuous phase used in stage c) advantageously does not comprise a thickener. It can comprise one or more hydrophilic surfactants.

The final emulsion is produced after a single pass through the high pressure homogenizer.

With a second pass, there would be a risk of bringing about a considerable reduction in the number of internal droplets present in the globules (by coalescence). This would result in premature escape of the active principle into the aqueous external phase.

Thus, a second pass through the high pressure homogenizer is highly inadvisable.

The concentration of hydrophilic surfactant in the aqueous continuous phase of stage c) is less than 0.02 times the critical micelle concentration; it is preferably less than 0.01 times the critical micelle concentration.

The critical micelle concentration (CMC) is defined as the concentration beyond which the surfactant molecules combine together to form spherical aggregations known as micelles (see, for example “Galenica 5, surfactants and emulsifiers”, vol. 5.1, page 101, published by Techniques et Documentation (Lavoisier)).

In the context of the invention, the concentration of hydrophilic surfactant in the aqueous continuous phase can be zero. In this case, it is highly desirable to add an additional surfactant as stabilizer to the monodisperse double emulsion exiting from the high pressure homogenizer, advantageously as rapidly as possible at the outlet of the high pressure homogenizer.

The additional surfactant which can be used as stabilizer of the monodisperse double emulsion is of the same type as that optionally present in the diluting aqueous phase; it is a hydrophilic surfactant.

This additional surfactant, and that optionally present in the diluting aqueous phase of stage c), can be nonionic, ionic, zwitterionic or amphoteric.

The hydrophilic surfactant of the diluting aqueous phase of stage c) advantageously exhibits a lipophilic-hydrophilic ratio (HLB value) of greater than 20, preferably of greater than 30.

Preferably, the HLB value is approximately 40.

The additional surfactant for its part preferably exhibits an HLB value of greater than 12.

Mention may be made, as hydrophilic nonionic surfactant, of:

the condensation product of an aliphatic fatty alcohol, preferably a C₈-C₂₂ fatty alcohol, with a C₂-C₃ alkylene oxide. The C₂-C₃ alkylene oxide can be ethylene oxide, propylene oxide or a mixture of ethylene oxide and of propylene oxide in any proportions. An example of such surfactants is the condensation product of lauryl alcohol (or n-dodecyl alcohol) with 30 mol of ethylene oxide;

the condensation product of an alkylphenol, in which the alkyl chain is a C₈-C₂₂ alkyl chain, with a C₂-C₃ alkylene oxide. Here again, the condensation products with ethylene oxide, propylene oxide or a mixture of ethylene oxide and of propylene oxide in any proportions are also advantageous. Mention may be made, as example of such surfactants, of the condensation product of n-nonylphenol with 10 mol of ethylene oxide;

the condensation product of a fatty acid, preferably a C₈-C₂₂ fatty acid, with a C₂-C₃ alkylene oxide, for example ethylene oxide or propylene oxide or a mixture of ethylene oxide and of propylene oxide in any proportions. These condensation products exhibit an alkoxylated chain at the hydroxyl functional group of the carboxyl group. Preferred surfactants from this group are the condensation products obtained from oleic acid, palmitic acid and stearic acid;

the condensation product of a C₈-C₂₂ fatty acid glyceride with a C₂-C₃ alkylene oxide, such as ethylene oxide and/or propylene oxide. Among these, ethoxylated glyceryl palmitate is preferred;

the condensation product of a C₈-C₂₂ fatty acid ester of sorbitol with a C₂-C₃ alkylene oxide which can be ethylene oxide, propylene oxide or their mixtures. These compounds are polysorbates. A preferred example is sold under the name Tween 80;

a polyacrylonitrile;

a polyalkylene glycol, preferably a polyalkylene glycol in which the oxyalkylene part is a C₂-C₃ part;

a water-soluble block copolymer of ethylene oxide and of propylene oxide. Preferably, a copolymer corresponding to the formula (I):

H—(OCH₂CH₂)ₐ—(O—CH(CH₃)—CH₂)_{b}—(OCH₂CH₂)ₐ—OH (I)

in which:

a is an integer between 50 and 120, preferably between 70 and 110; and

b is an integer between 20 and 100, preferably between 30 and 70.

Such polymers are sold by ICI under the Synperonic PE® trademark.

Among these, those exhibiting a molar mass of between 2 000 and 15 000 g/mol, preferably between 5 000 and 14 000 g/mol, preferably between 8 000 and 12 000 g/mol, will advantageously be selected.

The kinematic viscosity of the polymers of Synperonic PE® type is preferably between 150 and 1 200 mm².s⁻¹ at 100° C., better still between, 500 and 1 100 mm².s⁻¹.

Preference is more particularly given to Poloxamer 188 of formula (I) above in which a=75 and b=30.

Appropriate examples of hydrophilic anionic surfactants are:

alkyl ester sulfonates of formula R—CH(SO₃M)-COOR′, where R represents a C₈-C₂₀, preferably C₁₀-C₁₆, alkyl radical, R′ a C₁-C₆, preferably C₁-C₃, alkyl radical and M an alkali metal cation (sodium, potassium or lithium), substituted or unsubstituted ammonium (methyl-, dimethyl-, trimethyl- or tetramethylammonium, dimethylpiperidinium, and the like) or derivative of an alkanolamine (monoethanolamine, diethanolamine, triethanolamine and the like). Mention may very particularly be made of methyl ester sulfonates in which the R radical is a C₁₄-C₁₆ radical;

alkyl sulfates of formula ROSO₃M, where R represents a C₁₀-C₂₄, preferably C12-C20 and very particularly C₁₂-C₁₈ alkyl or hydroxyalkyl radical, M representing a hydrogen atom or a cation with the same definition as above, and their ethoxylenated (EO) and/or propoxylenated (PO) derivatives exhibiting, on average, from 0.5 to 6 EO and/or PO units, preferably from 0.5 to 3 EO and/or PO units; preference is given, among these, to sodium dodecyl sulfate;

alkylamide sulfates of formula RCONHR′OSO₃M, where R represents a C₂-C₂₂, preferably C₆-C₂₀, alkyl radical and R′ a C₂-C₃ alkyl radical, M representing a hydrogen atom or a cation with the same definition as above, and their ethoxylenated (EO) and/or propoxylenated (PO) derivatives exhibiting, on average, from 0.5 to 60 EO and/or PO units;

salts of saturated or unsaturated C₈-C₂₄, preferably C₁₄-C₂₀, fatty acids, C₉-C₂₀ alkylbenzenesulfonates, primary or secondary C₈-C₂₂ alkyl sulfonates, alkyl glycerol sulfonates, the sulfonated polycarboxylic acids described in GB-A-1 082 179, paraffin sulfonates, N-acyl-N-alkyltaurates, alryl phosphates, alkyl isethionates, alkylsuccinamates, alkylsulfosuccinates, monoesters or diesters of sulfosuccinates, N-acylsarcosinates, sulfates of alkyl glycosides, or polyethoxy-carboxylates, the cation being an alkali metal (sodium, potassium or lithium), a substituted or unsubstituted ammonium residue (methyl-, dimethyl-, trimethyl- or tetramethylammonium, dimethylpiperidinium, and the like) or derivative of an alkanolamine (monoethanolamine, diethanolamine, triethanolamine, and the like);

phosphate or alkyl phosphate esters; and

alginates.

Use may be made, as hydrophilic cationic surfactant, of:

quaternary ammonium salts, such as tetradecyl-trimethylammonium bromide, and

addition salts of fatty amines with acids. The term “fatty amine” is understood to mean amines comprising long hydrcocarbonaceous chains, that is to say comprising from 8 to 24 carbon atoms. An example of preferred fatty amine is dodecylamine.

Other surfactants are hydrophilic amphoteric and zwitterionic surfactants:

those of betaine type, such as betaines, sulfobetaines, amidoalkyl betaines, sulfobetaines, alkyl sultaines or alkyl trimethyl sulfobetaines,

condensation products of fatty acids and of protein hydrolyzates,

alkyl amphopropionates or dipropionates,

amphoteric derivatives of alkylpolyamines, such as Amphionic XL, sold by Rhone-Poulenc, or Ampholac 7T/X and Ampholac 7C/X, sold by Berol Nobel,

cocoamphoacetates and cocoamohodiacetates.

In a particularly advantageous way, the surfactant present in the aqueous continuous phase of stage c) is chosen from a fatty acid ester of sorbitol; the condensation product of a fatty acid ester of sorbitol with an alkylene oxide; an alkyl sulfate or an ethoxylenated and/or propoxylenated derivative of the latter; a quaternary ammonium salt; and their mixtures.

Furthermore, it is preferable for the additional hydrophilic surfactant added to the final double emulsion exiting from the homogenizer to be chosen from a fatty acid ester of sorbitol; the condensation product of a fatty acid ester of sorbitol with an alkylene oxide; a water-soluble block copolymer of ethylene oxide and of propylene oxide; and their mixtures.

The concentration of additional surfactant is to be adjusted by a person skilled in the art so as to guarantee the encapsulation of the active principle and to avoid breaking the emulsion. By way of indication, if the HLB of the hydrophilic, surfactant is greater than 30, then the concentration of said surfactant will preferably be less than 1 times its CMC. If the HLB of the hydrophilic surfactant is less than 20, then the concentration of said surfactant, will preferably be less than 100 times its CMC.

According to a particularly preferred embodiment of the invention, the aqueous phase of the starting emulsion Ei comprises at least one water-soluble active substance.

Such active substances are preferably in the form of water-soluble polymers or salts.

Nevertheless, it can be any type of active substance generally used in one or more of the pharmaceutical, cosmetic, plant protection or foodstuff fields and/or paints.

It can thus be chosen from vitamins (E, C), enzymes, insulin, analgesic, antimitotic, antiinflammatory or antiglaucoma agents, vaccines, anticancer agents, narcotic antagonists, detoxifying agents (salicylates, barbiturates), depilatory agents, agents for correcting or masking tastes, salts which are soluble in water, acids, bases, vinegar, glucose, colorants, preservatives or their mixtures.

When the active substance is not in the form of a water-soluble polymer or organic or inorganic salt, it is advantageous to add, to said aqueous internal phase, a salt, such as an alkali metal chloride (NaCl or KCl), or a water-soluble polymer, such as an alginate, hydroxyethylcellulose, carboxymethylcellulose or a poly(acrylic acid), or alternatively a monosaccharide glucide, such as fructose, lyxose, arabinose, ribose, xylose, glucose, altrose, mannose, idose, galactose, erythrose, threose, sorbose, fucose or rhamnose, glucose being markedly preferred.

The concentration of active substance depends on the nature of the active substance and of the application envisaged.

When the emulsion Ei comprises such an active substance, it is desirable for the aqueous continuous phase of stage c) to comprise one or more agents for balancing the osmotic pressure.

A person skilled in the art will be able to employ any one of the balancing agents commonly used in the art as balancing agents which can be used according to the invention.

Particularly preferred examples thereof are sorbitol, glycerol and inorganic salts, such as ammonium salts and alkali metal or alkaline earth metal salts.

According to a preferred embodiment of the invention, a monosaccharide glucide, such as fructose, lyxose, arabinose, ribose, xylose, glucose, altrose, mannose, idose, galactose, erythrose, threose, sorbose, fucose or rhamnose, is used, glucose being markedly preferred.

A person skilled in the art will easily set the concentration of agent for balancing the osmotic pressure as a function of the concentration of active substance present in the aqueous internal phase.

More specifically, the concentration of balancing agent will be determined so as to ensure osmotic balance between the aqueous internal phase of the final double emulsion and the aqueous external continuous phase of the double emulsion. It depends on the osmolality of the hydrophilic active substance or substances (present in the aqueous internal phase) and on the osmolality of said balancing agent in the aqueous continuous phase.

The method of the invention makes it possible to prepare double emulsions with a size of the globules varying between 1 and 50 μm, in particular in the range 2 and 20 μm, better still between 2 and 10 μm.

The value of the diameter of the droplets of the emulsion Ei can be measured by employing any one of the known methods of the prior art: two of these methods are commonly used in the art.

The first is phase contrast microscopy and the second is laser particle sizing. A third method, appropriate for the case of emulsions composed of at least 65% by weight of dispersed phase, consists in filling, with the double emulsion, a cell which allows the transmission of at least 80% of the incident light. By sending a laser beam through the cell and by placing a screen on the path after the cell, a ring of scattering is observed, the position of which gives directly the mean diameter 2a of the droplets by using the classic formula:

2a=λ×(n×sin θ/2)⁻¹

θ being the angle formed by the position of the ring and the initial beam,

λ being the wavelength of the light, and

n being the refractive index of the medium.

The concentration of surfactant present in the aqueous continuous phase of stage c) determines the size of the globules in the final double emulsion.

The higher this concentration, the smaller the diameter of the globules of the final double emulsion.

Another way of controlling the size of the globules of the final double emulsion involves controlling the total amount of lipophilic surfactant present in the oily phase of the monodisperse inverse emulsion prepared in stage b). This amount does not correspond exactly to the sum of the lipophilic surfactant initially present in the inverse emulsion Ei and of the lipophilic surfactant optionally present in the diluting oily phase added in stage b), but is less than it.

In fact, a portion of the surfactant is adsorbed at the oil-water interface, that is to say at the surface of the droplets of aqueous phase.

A good approximation of the amount of residual surfactant (nonadsorbed) remaining in the oily continuous phase of the monodisperse inverse emulsion obtained on conclusion of stage b) is given by the equation:

$$C = {C}_{T} - \frac{3 ∅}{{a}_{0} R ( 1 - ∅ ) Na}$$

in which:

C is the desired residual concentration of surfactant;

C_{T} is the total concentration of the lipophilic surfactant in the inverse emulsion, namely the sum of the surfactant initially present in the emulsion Ei and of the lipophilic surfactant present in the diluting oily phase added in stage b);

Ø is the fraction by volume of the droplets of aqueous phase, namely the ratio of the volume of the aqueous phase of the inverse emulsion to the total volume of the inverse emulsion;

R is the mean radius of the water droplets;

Na is Avogadro's number;

a₀ is the surface area occupied by the surfactant adsorbed at the oil-water interface;

a₀ can be obtained from the curve giving the change in the water/oil interfacial tension as a Function of the concentration of the lipophilic surfactant using Gibbs' equation (the method of calculation is well known in the art; it is described in particular in Physical Chemistry, fifth edition, P. W. Atkins, Oxford University Press, 1994).

In an alternative form, it is possible to adjust, experimentally and a posteriori, the amount of surfactant remaining in the oily phase of the inverse emulsion, which amount does not take into account the surfactant adsorbed at the water-oil interface.

To do this, it is sufficient to exchange the oily phase the inverse emulsion, the exact concentration of lipophilic surfactant in which is unknown, with a replacement oily phase with a known concentration of surfactant.

This exchange is carried out simply by a person skilled in the art, for example by employing the following treatment stages:

i) centrifuging the monodisperse inverse emulsion at an appropriate centrifugal force, so as to prevent any coalescence of the droplets of aqueous phase, until separation by settling of the phases. The centrifugal force is preferably kept below 15 000 g (where g is the acceleration of gravity, namely approximately 9.8 m.s⁻²). This centrifuging is usually carried out for less than 30 minutes. On completion of the centrifuging, two phases are obtained: a first phase, composed of droplets of aqueous phase, and an oily phase; in the majority of cases, the oily phase is the supernatant phase, the sedimented phase being composed of droplets of aqueous phase;

ii) separating the oily phase in a way known per se, for example by removing with a pipette;

iii) adding a replacement oily phase of known formulation and in particular with a known concentration of lipophilic surfactant;

iv) redispersing the emulsion under appropriate shearing, so as to avoid subsequent fractionation of the inverse emulsion. Moderate mechanical stirring is generally suitable. To do this, use will be made, for example, of a mechanical vibrator. In an alternative form, the emulsion can be left standing for several hours. Simple manual stirring subsequently makes it possible to redisperse it.

In a particularly advantageous way, this treatment sequence composed of stages i) to iv) is repeated several times and in this order, the oily phase added in stage iii) being identical in each sequence.

Generally, this sequence is repeated at least twice.

The knowledge of the exact concentration (denoted as true concentration) of surfactant in the oily phase makes possible perfect control of the size of the globules of the final double emulsion.

The method of the invention finds applications in numerous fields, such as the pharmaceutical field, the cosmetic field, the detergent field, the liquid crystal display field, the plant protection field and water paints. The emulsions of the invention are also of use in the treatment of surfaces.

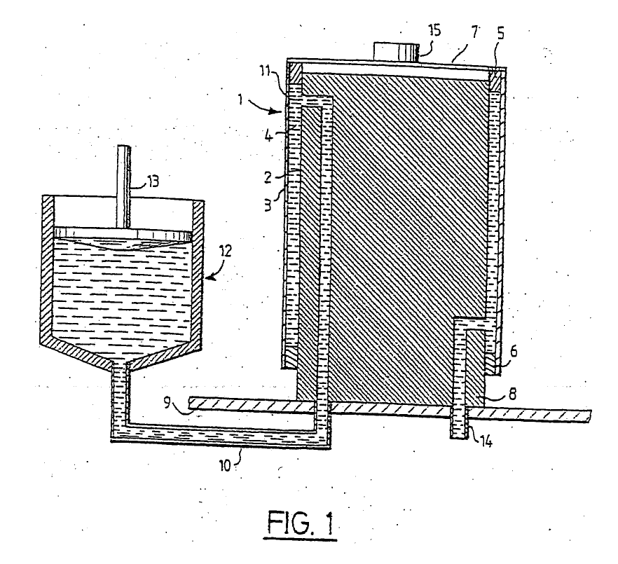

The following examples, which refer to FIGS. 1 to 4, illustrate the invention more fully.

For all the examples, the device used for the preparation of monodisperse inverse emulsions from corresponding polydisperse emulsions is the Couette cell represented in FIG. 1: the latter is composed of two concentric cylinders 2 and 3 in constant rotation with respect to one another. In FIG. 1, the internal cylinder 2 is immobile, whereas the external cylinder 3 is driven with a uniform rotational movement with respect to a drive axis 15. The concentric cylinders 2 and 3 define an annular chamber 4. Two annular leaktight ball bearings 5 and 6 are positioned at the top and bottom ends of the chamber 4. A lid 7, the dimensions of which correspond to those of the external cylinder 3, closes the top part of the device 1.

The concentric cylinders 2 and 3 are offset with respect to one another in the direction of the length, so that the bottom part 8 of the internal cylinder rests on a flat support 9.

The Couette cell 1 represented in fig. 1 also comprises a feed pipe 10 for polydisperse emulsion which passes through the support 9 and emerges in the top part 11 of the chamber 4. The other end of the feed pipe is connected to a tank 12 containing the polydisperse emulsion. The feed flow rate of polydisperse emulsion is controlled by a piston 13. The bottom part of the chamber 4 diametrically opposite the point 11 is equipped with a discharge pipe 14 for the mono disperse emulsion which passes through the flat support 9.

The device of FIG. 1 makes possible the continuous preparation of the target monodisperse emulsion. During production, the chamber 4 is fed continuously with polydisperse emulsion via the pipe 10. The polydisperse emulsion moves through the chamber 4 while being subjected to shear forces generated by the uniform rotation of the external cylinder 3 about itself.

In such a device, the polydisperse emulsion is subjected to a constant shear rate, the shear rate being defined here as the ratio of the linear velocity at the point of contact with the surface of the external cylinder 3 to the difference (R₃-R₂), where R₂ and R₃ are respectively the radii of the internal cylinder 2 and of the external cylinder 3.

The size of the droplets of emulsion Ei was determined in all cases by phase contrast microscopy and by laser particle sizing.

### EXAMPLE 1

Preparation of a Monodisperse Double Emulsion

In this example, the presence of an active substance in the aqueous internal phase is simulated by introducing sodium chloride into the latter.

In a first step, a water-in-sorbitan monooleate (Span 80) polydisperse inverse emulsion is prepared; the Span 80 acts both as oil and as surfactant. This inverse emulsion is prepared by introducing a 0.4M aqueous sodium chloride solution into a continuous phase maintained under constant stirring and composed of sorbitan monooleate. The amount of aqueous solution added is such that the aqueous dispersed phase represents 85% of the total mass of the emulsion.

This inverse emulsion is subsequently sheared at a shear rate of 1 890 s⁻¹ in a Couette device characterized by a separation of 100 μm. The inverse-emulsion Ei° obtained is monodisperse, the mean diameter of the droplets of aqueous internal phase being 0.35 μm.

The, inverse emulsion Ei° is subsequently diluted in dodecane, so that the aqueous dispersed phase represents approximately 20% of the total mass of the emulsion. This dilution operation consists in gradually adding the dodecane to the inverse emulsion Ei° while maintaining gentle and constant stirring.

The inverse emulsion obtained is “washed”, so as to know the concentration of lipophilic surfactant in the continuous oily phase. To do this, three centrifuging cycles are carried out or the supernatant oily phase is replaced by a solution composed of dodecane and of 2% by weight of sorbitan monooleate.

The diluted inverse emulsion is stable and has the following characteristics:

Composition of the continuous phase; Dodecane and 2% by weight of sorbitan monooleate;

Composition of the dispersed phase: 0.4M aqueous sodium chloride solution;

Ratio of the volume of the aqueous dispersed phase to the total volume of the inverse emulsion: approximately 20%;

Mean diameter of the drops of aqueous solution: 0.35 μm;

Polydispersity of thee distribution by volume of the sizes of the droplets of aqueous solution: approximately 25%, the polydispersity being defined as the ratio of the standard deviation of the curve representing the variation in the volume occupied by the dispersed material as a function of the diameter of the droplets to the mean diameter of the droplets of aqueous phase.

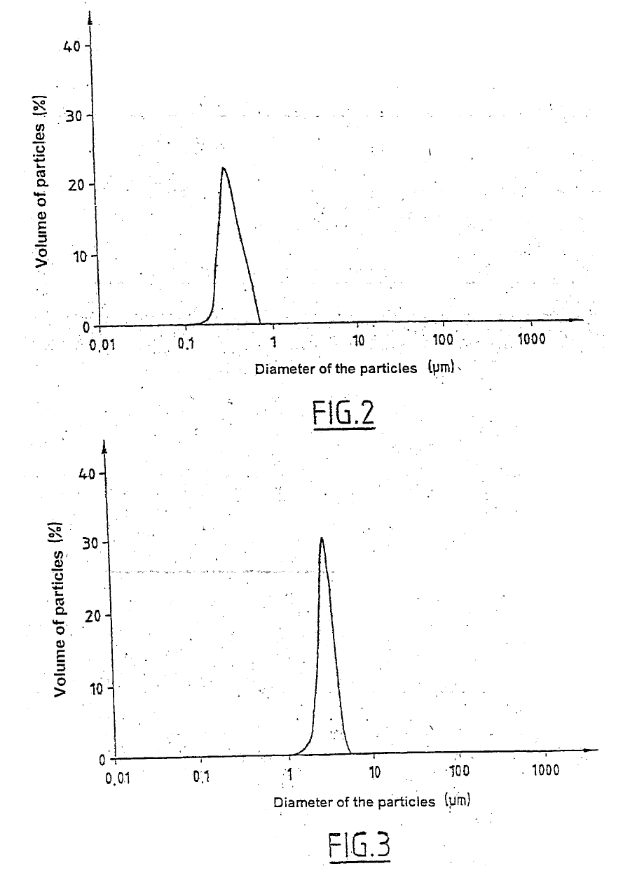

The particle size distribution of the diluted inverse emulsion is represented in FIG. 2.

The high pressure homogenizer comprises 2 tanks for the introduction of an aqueous continuous phase, on the one hand, and of the diluted inverse emulsion, on the other hand. The preceding inverse emulsion is introduced into one of the tanks and the aqueous continuous phase of the final double emulsion (aqueous continuous phase) into the other. The aqueous continuous phase is composed of water, of 10.5% by weight of glucose (this amount of glucose was chosen in order to balance the osmotic pressures with the aqueous dispersed phase of the inverse emulsion composed of 0.4M salt) and of sodium dodecyl sulfate at 0.005 times the critical micelle concentration. The two fluids are subsequently emulsified in the mixing chamber of the homogenizer at a pressure of approximately 300 bar. The diameter of the outlet orifice chosen is 0.62 mm.

At the outlet of the device of the high pressure homogenizer, sodium dodecyl sulfate is immediately added, so as to obtain a concentration of 0.1 times the critical micelle concentration in the aqueous continuous phase of the double emulsion.

The final double emulsion is stable and has the following characteristics:

Composition of the aqueous continuous phase: water, 10.5% by weight of glucose, and sodium dodecyl sulfate at 0.1 times the CMC;

Composition of the dispersed phase: composition of the preceding inverse emulsion;

Ratio of the volume of the inverse emulsion dispersed phase to the total volume of the double emulsion: approximately 50%;

Mean diameter of the globules of inverse emulsion: 3.5 μm;

Polydispersity of the distribution by volume of the sizes of the globules of inverse emulsion: approximately 25%, the polydispersity being defined as the ratio of the standard deviation of the curve representing the variation in the volume occupied by the dispersed material as a function of the diameter of the globules to the mean diameter of the globules of inverse emulsion.

The particle size distribution of the final double emulsion is represented in FIG. 3.

### EXAMPLE 2

Study of the Influence of the Concentration of Sorbitan Monooleate in the Continuous Oily Phase of the Inverse Emulsion and of the Concentration of Sodium Dodecyl Sulfate in the Aqueous Continuous Phase of the Double Emulsion on the Diameter of the Globules of the Double Emulsion.

The inverse emulsion is washed in the same way as in example 1 with a continuous phase composed of dodecane and of sorbitan monooleate at 1% and 2% by weight. Two inverse emulsions comprising two concentrations of sorbitan monooleate in the continuous oily phase are thus obtained.

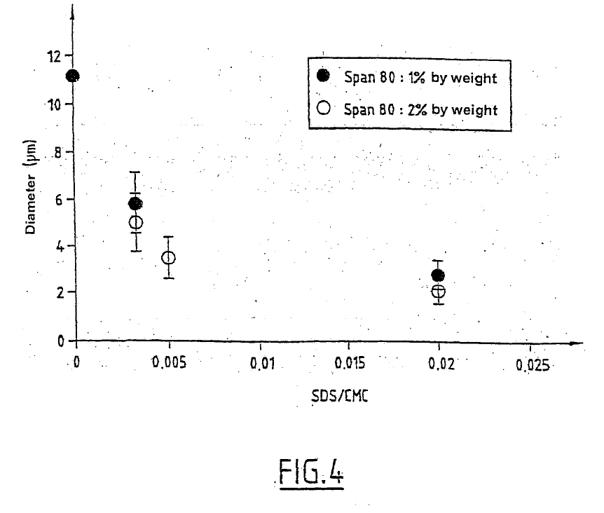

For each of these inverse emulsions, 4 double emulsions are prepared from aqueous continuous phases comprising different concentrations of sodium dodecyl sulfate in the aqueous continuous phase: 0, 0.003, 0.005 and 0.02 times the CMC. For each of the double emulsions obtained, the mean diameter of the globules is measured. The change in this diameter as a function of the concentration of sodium dodecyl sulfate in the aqueous continuous phase of the double emulsion for two concentrations of sorbitan monooleate in the oily continuous phase of the inverse emulsion is presented in FIG. 4. It should be noted that, on the abscissa, SDS/CMC represents the ratio of the concentration of sodium dodecyl sulfate to the critical micelle concentration.

A decrease in the size of the globules of the double emulsion with the concentration of sodium dodecyl sulfate is observed.

Furthermore, for one concentration of sodium dodecyl sulfate, it is found that the size of the globules of the double emulsion decreases as the concentration of sorbitan monooleate increases (see FIG. 4).

1. A method for preparing a monodisperse double emulsion of water-in-oil-in-water type, characterized in that it comprises the stages consisting in:
a) subjecting a polydisperse emulsion Ei of water-in-oil type, comprising from 50 to 99% by weight of an aqueous phase, to controlled shearing so that the same maximum shearing is applied to the entire emulsion, so as to obtain the corresponding monodisperse inverse emulsion;
b) adding to said emulsion, without phase inversion, the necessary amount of a diluting oily phase, so that the aqueous phase of the resulting emulsion represents less than 50% by weight of the total weight of the emulsion; and
c) introducing the resulting emulsion into a high pressure homogenizer, together with an aqueous continuous phase, the respective amounts of said emulsion and of said aqueous continuous phase being such that the resulting double emulsion comprises up to 50% by weight of droplets of inverse emulsion with respect to the total weight of the emulsion, said aqueous continuous phase comprising a concentration of hydrophilic surfactant of less than or equal to 0.02 times the critical micelle concentration.

2. The method as claimed in claim 1, characterized in that the controlled shearing is carried out by bringing said polydisperse emulsion Ei pinto contact with a moving solid surface, the rate gradient characterizing the flow of the emulsion being constant in a direction perpendicular to said moving solid surface.

3. The method as claimed in either one of claims 1 and 2, characterized in that the shearing is carried out using a cell composed of two concentric cylinders in rotation with respect to one another.

4. The method as claimed in either one of claims 1 and 2, characterized in that the shearing is carried out using a cell composed of two parallel plates in oscillating movement with respect to one another.

5. The method as claimed in either one of claims 1 and 2, characterized, in that the shearing is carried out using a cell composed of two concentric disks in rotation with respect to one another.

6. The method as claimed in any one of the preceding claims, characterized in that the maximum value of the shear rate is from 1 to 1×10⁵ s⁻¹, preferably from 100 to 5 000 s⁻¹.

7. The method as claimed in any one of the preceding claims, characterized in that the emulsion Ei comprises from 70 to 95% by weight of aqueous phase, preferably from 80 to 90% by weight.

8. The method as claimed in any one of the preceding claims, characterized in that, in stage b), the amount of oily phase added is such that the aqueous phase of the resulting emulsion represents 35% by weight or less of the total weight of the emulsion, preferably 20% by weight or less.

9. The method as claimed in any one of the preceding claims, characterized in that, in stage c), the viscosity of the emulsion introduced into the high pressure homogenizer, on the one hand, and the viscosity of the aqueous continuous phase, on the other hand, are less than 0.1 Pa·s, preferably less than 0.01 Pa·s.

10. The method as claimed in any one of the preceding claims, characterized in that the surfactant present in the aqueous continuous phase of stage c) exhibits a lipophilic-hydrophilic ratio (HLB value) of greater than 20, preferably of greater than 30.

11. The method as claimed in any one of the preceding claims, characterized in that the aqueous continuous phase of stage c) comprises, as surfactant, a fatty acid ester of sorbitol; the condensation product of a fatty acid ester of sorbitol with an alkylene oxide; an alkyl sulfate or an ethoxylenated and/or propoxylenated derivative of the latter; a quaternary ammonium salt; or their mixtures.

12. The method as claimed in any one of the preceding claims, characterized in that the concentration of surfactant in the aqueous continuous phase of stage c) is less than 0.01 times the critical micelle concentration.

13. The method as claimed in any one of the preceding claims, characterized in that the aqueous phase of the emulsion Ei comprises an active substance and the aqueous continuous phase of stage c) comprises an agent for balancing the osmotic pressure.

14. The method as claimed in any one of the preceding claims, characterized in that an additional surfactant is added as stabilizer to the monodisperse double emulsion resulting from stage c).

15. The method as claimed in claim 14, characterized in that said surfactant exhibits a lipophilic hydrophilic ratio (HLB value) of greater than 12.

16. The method as claimed in either one of claims 14 and 15, characterized in that the surfactant is chosen from a fatty acid ester of sorbitol; the condensation product of a fatty acid ester of sorbitol with an alkylene oxide; a water-soluble block copolymer of ethylene oxide and of propylene oxide; and their mixtures.

17. The method as claimed in any one of the preceding claims, characterized in that the concentration of hydrophilic surfactant in the aqueous continuous phase of stage c) is adjusted in order to vary the size of the droplets of inverse emulsion in the final double emulsion.

18. The method as claimed in any one of claims 1 to 16, characterized in that the true concentration of the lipophilic surfactant present in the oily phase of the monodisperse inverse emulsion obtained on conclusion of stage b) is adjusted in order to vary the size of the droplets of inverse emulsion in the final double emulsion.

19. The method as claimed in claim 18, characterized in that the true concentration of the lipophilic surfactant is adjusted by carrying out, after stage b) and before stage c), the treatment sequence composed of the stages consisting in:
i) centrifuging the inverse emulsion resulting from stage b), without bringing about coalescence of the droplets of aqueous phase, until separation by settling of the phases;
ii) separating the oily phase in a way known per se;
iii) adding, to the remaining phase composed of the sedimented droplets of aqueous phases stabilized by the lipophilic surfactant, a replacement oily phase with a predetermined concentration of lipophilic surfactant;
iv) redispersing the emulsion under appropriate shearing, so as to avoid subsequent fragmentation of the droplets of aqueous phase.

20. The method as claimed in claim 19, characterized in that the inverse emulsion resulting from stage b) is subjected at least twice, and in this order, to said treatment sequence composed of stages i) to iv), this being carried out before carrying out stage c).
